(19) United States
(12) Patent Application Publication
(10) Pub. No.: US 2003/0056226 A1
(43) Pub. Date: Mar. 20, 2003

(54) Implementation of virtual telephony endpoints in communications gateways

(76) Inventors: David B. Lazarus, Elkins Park, PA (US); Robert C. Stein, Coopersburg, PA (US)

Correspondence Address: Wendy W. Koba, Esq., PO Box 556, Springtown, PA, 18081, US

(21) Appl. No.: 09/956,683

(22) Filed: Sep. 20, 2001

(51) Int. Cl. H04N 7/173

(52) U.S. Cl. 725/129; 725/106; 725/110; 725/111; 725/122

(57) ABSTRACT

The creation of “virtual telephony endpoints” within a subscriber's location allows for diverse types of telephone sets, connected via different types of communication networks (e.g., PSTN, Ethernet, power line connections, etc.), to be grouped together and perform as “extensions” as in the sense of traditional wired telephone networks, with a “virtual” telephone number assigned to each virtual telephony endpoint (VTEP). The grouping of the telephone sets within each VTEP can be configured and continuously re-configured by the subscriber, as can the number of separate VTEPs within a single location.

### TECHNICAL FIELD

The present invention relates to providing telecommunications services in a home/small business through an on-site communications gateway and, more particularly, to configuring the gateway to create “virtual telephony endpoints” for the interoperability of multiple telephone devices supplied through multiple networks into the home/small business.

### BACKGROUND OF THE INVENTION

Broadband hybrid-fiber/coax (HFC) networks are becoming more prevalent in communication systems throughout the world and as such provide a flexible, cost-effective platform for offering a wide range of telecommunications services to residences and businesses (commonly referred to as “subscribers” for the purposes of the present invention). These networks also support the reception of return path signals, which are defined as signals generated by units in or near the subscriber and which send data or voice signals from the subscriber to the network through a cable system.

By providing telecommunications services over HFC networks, network operators can enhance their service offerings to include voice, Internet access, and other new and unique multimedia services. Each subscriber requires the use of a communications gateway device (also referred to in the art as a “broadband/telephone interface”, or BTI), located at or near the residence/business to communicate between a connected, bidirectional cable (which then joins various cables from each home at a headend, for eventual coupling to an optical fiber broadband transmission path) and various communication devices in the home or office. In particular, a communications gateway is used for transmitting and receiving data, voice or video signals over an HFC network. A conventional communications gateway allows for the connection of, typically, four separate analog telephone lines in the home (i.e., four separate telephone lines/numbers). These lines are connected to “subscriber line interface circuits”, or SLICs, which terminate at conventional telephone connectors (e.g., RJ-11 connectors). Each one of the SLIC connections is associated in a one-to-one unique relationship with exactly one HFC access network endpoint, identified by a unique telephone number. As is commonly known, each number may have a number of telephone devices (“extensions”) connected through in-home wiring to a single telephone number.

A problem has begun to develop with the use of a conventional communications gateway when the gateway device is required to support one or more other “home networking” interfaces in addition to the traditional SLIC connections. Various ones of these network options, as they exist today, include HomeRF™ communication (a radio-based home networking technology), HomePNA™ communication (a phone line-based home networking technology), HomePlug™ communication (a power line-based networking technology), and Bluetooth™ communication (a radio-based ad hoc networking technology). Other home networking technologies exist as well. With all of these available communication options, a subscriber may wish to associate selected telephone sets connected to the home network with one of the existing network telephone numbers. Ideally, a subscriber would like to accomplish this without requiring assistance from the telephony service provider.

### SUMMARY OF THE INVENTION

The need remaining in the prior art is addressed by the present invention, which relates to providing telecommunications services in a home/small business through an on-site communications gateway and, more particularly, to configuring the gateway to create “virtual telephony endpoints” for the interoperability of multiple telephone devices supplied through multiple networks into the home/small business.

In accordance with the present invention, a communications gateway is modified to directly support a number of telephone lines (in the conventional manner through SLIC connections), with the remaining ports used to support telephones connected to one or more alternative networks (e.g., HPNA, HomeRF, HomePlug, Ethernet, etc.). Telephone sets throughout a home, connected to various networks can be “grouped” together for the purposes of the present invention and are configured to act as a single telephone line, defined as a “virtual telephony endpoint” (VTEP).

It is an aspect of the present invention that a VTEP is addressed by a telephone number (for the purposes of receiving inbound calls) that is shared by all physical endpoints defined as belonging to that VTEP group. When one phone in a VTEP group initiates an outbound call, all other phones in that group may join in on the call as “extensions” (as in a conventional POTS network with multiple telephones in a single home), regardless of their individual home network communication connection. For inbound calls, all telephones on a VTEP will ring until one picks up to answer the call.

Other and further aspects of the present invention will become apparent during the course of the following discussion and by reference to the accompanying drawings.

### BRIEF DESCRIPTION OF THE DRAWINGS

Referring now to the drawings,

FIG. 1 illustrates an exemplary home network installation that may utilize the modified communications gateway of the present invention to provide interconnection of various telephone devices;

FIG. 2 is an exemplary interconnection of various telephone sets (as depicted in FIG. 1) interconnected using the VTEP communications gateway of the present invention;

FIG. 3 shows, in block diagram form, exemplary hardware architecture for a communications gateway of the present invention, used for connecting an HFC access network to a home network;

FIG. 4 illustrates the signal flow between an HFC access network, SLIC interface and HPNA interface, through a VTEP communications gateway formed in accordance with the present invention;

FIG. 5 contains a class diagram illustrating the relationship between endpoint classes that implement the VTEPs;

FIG. 6 is a class diagram illustrating the relationship between a physical endpoint and the various types of voice terminals that may be supported by the communications gateway;

FIG. 7 illustrates the basic classes required for the communications gateway to operate on a DOCSIS network; and

FIG. 8 contains a diagram illustrating the operation of the VTEPs in accordance with the present invention.

### DETAILED DESCRIPTION

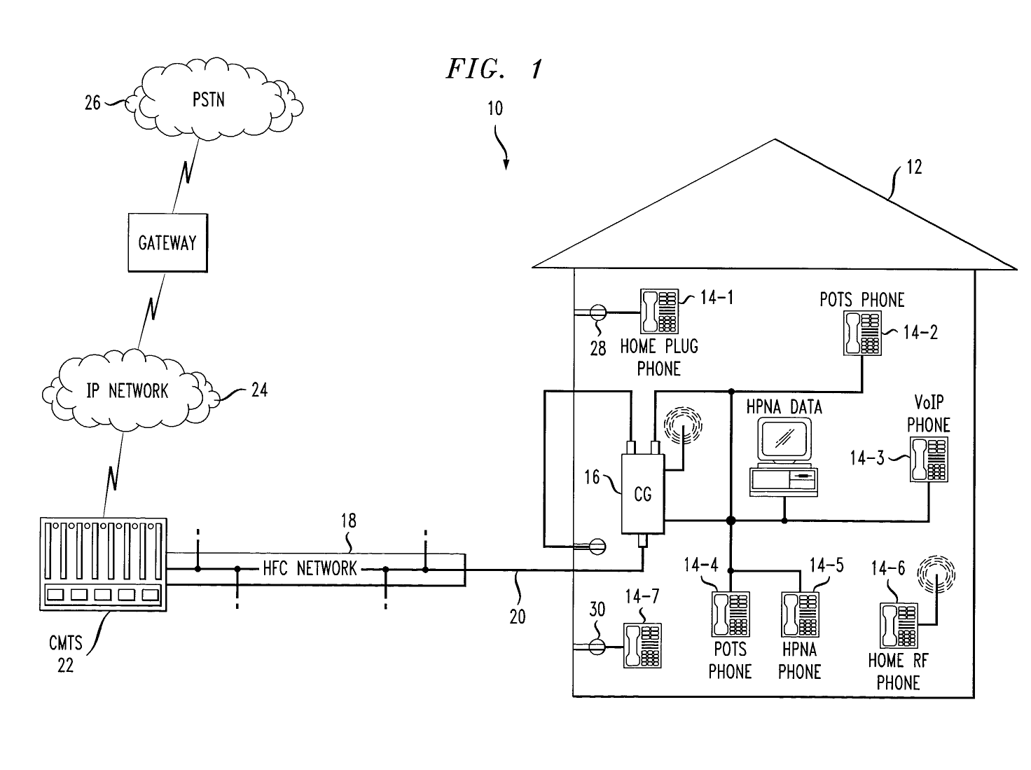

An exemplary arrangement 10 that may utilize the virtual telephony endpoint (VTEP) communications gateway of the present invention is illustrated in FIG. 1. As shown, an exemplary home 12 includes a plurality of telephone sets 14-1, 14-2, 14-3, . . . , 14-7, connected through a communications gateway 16 to an HFC network 18 via a cable connection 20. Additional subscribers are also coupled to HFC network 18 via other cable drops, as shown in FIG. 1. It is to be understood that the various subscriber locations could comprise a residence, a small office/home office (SOHO) environment, or a multiple unit dwelling. The remainder of the present discussion will utilize a residence as an example for the sake of discussion only, and should not be considered as limiting the scope of the present invention.

Referring back to FIG. 1, a simplified network connection is shown, including a cable modem termination system (CMTS) 22 connected to the headend of HFC network 18, and used to provide bidirectional communication between subscriber residence 12 and various communication networks, such as an IP network 24 and PSTN 26.

If all of the telephones 14 in residence 12 were traditional phones directly connected to PSTN 26, they could be wired in predetermined combinations to allow for (for example) four different phone lines (i.e., different telephone numbers) to terminate in the home. To date, most homes have only a single telephone line—a single telephone number—with the various phones wired as “extensions” off of the single telephone line. An increasing number of residences have two different telephone lines (a separate line for computer connections, a fax machine, or a second phone line for their children, for example), and some have three different lines. In any event, when all of the telephones in a residence communicate through the traditional telecommunications network, various subsets of the telephones may be wired together in desired combinations to allow for various ones of the different lines to have extension phones connected to the line. Such is not the case when, as here, different communications networks are used to provide voice communication service to several different telephones at the same location.

Referring to FIG. 1, various different home telecommunications networks are illustrated as used to provide voice communication services within residence 12. For example, telephone sets 14-1 and 14-7 are connected through power utility connections 28 and 30, respectively, and support voice communication over the in-place electric power utility line (e.g. HomePlug). Traditional POTS (plain old telephone service) telephones 14-2 and 14-4 are connected, via RJ-11 telephone jacks to communications gateway 16. A data connection (e.g., Ethernet) is used to support voice over IP (VOIP) connection to telephone set 14-3, and a HomePhone Network (HPNA) is used for communication via telephone set 14-5. Also shown in FIG. 1 is an RF network-based connection (e.g., Bluetooth) between communications gateway 16 and telephone set 14-6. Details of these various networks are discussed hereinbelow.

In one exemplary embodiment, this set of seven different telephone devices may be deployed as follows: Traditional POTS telephones 14-2 and 14-4 are located in a home office and master bedroom, respectively, and connected to communications gateway 16 through conventional telephone wiring that pre-dates installation of HFC network equipment. The HPNA connection is installed in the home office to accommodate a second telephone line through telephone set 14-5, with the data connection also terminating in the home office (for VOIP telephone set 14-3). Thus, the additional home office telephone lines are provided without requiring new wiring through the existing telephone network. The HomeRF telephone 14-6 is located in a new room added on to the house, and thus extends the original telephone line. The power line connections to telephones 14-1 and 14-7 are used to provide extensions, off the original line, to an upstairs bedroom and the basement. Without the capability of controlling the various telephone networks and the number and location of telephone sets associated with each network, a subscriber is at the mercy of the various service providers in terms of organizing and controlling the operation of each of these different types of telephone set devices.

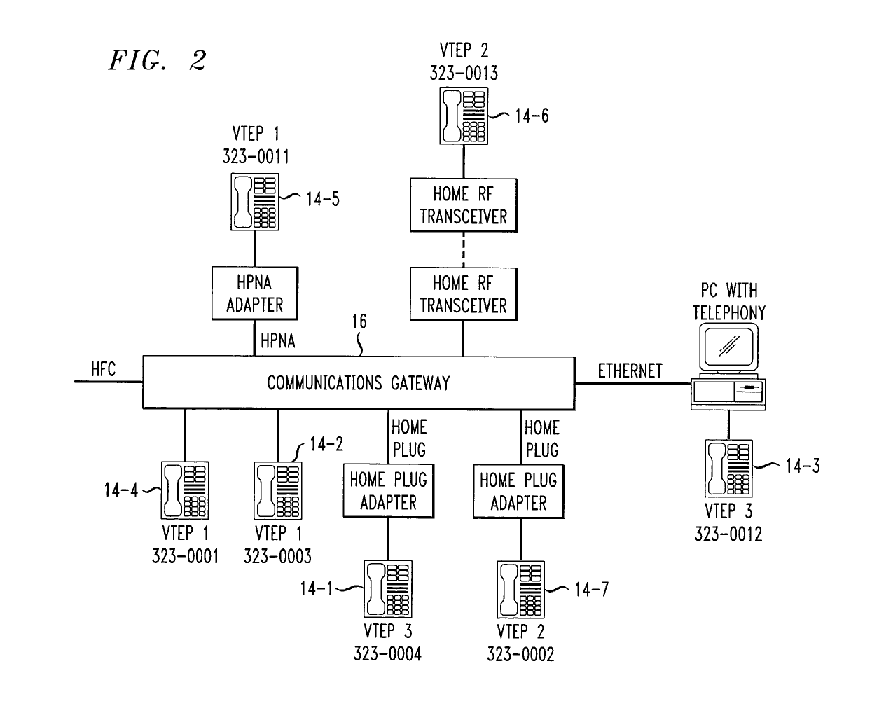

FIG. 2 illustrates a particular grouping of several telephone sets 14 into three separate “virtual telephone endpoints” (VTEPs) in accordance with the present invention, where the implementation of VTEPs overcomes the problems encountered when multiple voice communication services are available within a single location (such as a residence or small office). As shown, each telephone has its own telephone number, as assigned using the North American Dialing Plan (NADP) to each of the seven separate telephone sets. It is a purpose of the present invention to override this numbering scheme and utilize a “virtual”, group number for each VTEP grouping. Table I, as outlined below, defines an exemplary grouping of the telephone sets of FIGS. 1 and 2, and shows their assigned VTEP telephone numbers:

TABLE I

| VTEP Number | NADP Number | Phone Type |
|---|---|---|
| 555-323-1001 | 555-323-0001 | POTS telephone 14-4 |
| | 555-323-0011 | HPNA telephone 14-5 |
| 555-323-1002 | 555-323-0002 | HomePlug telephone 14-7 |
| | 555-323-0003 | POTS telephone 14-2 |
| | 555-323-0013 | HomeRF telephone 14-6 |
| 555-323-1003 | 555-323-0004 | HomePlug telephone 14-1 |
| | 555-323-0012 | VOIP telephone 14-3 |

In this particular example, therefore, the multiple telephone lines and voice terminals are grouped into three separate VTEPs, where each VTEP functions as a single telephone termination. In accordance with the present invention, each VTEP group is addressed by a shared telephone number (VTEP group 1 sharing 555-323-1001, VTEP group 2 sharing 555-323-1002, and VTEP group 3 sharing 555-323-1003). Accordingly, when a telephone call is placed to one of the shared numbers (i.e., an inbound call), all of telephones in that VTEP will ring together (with the same cadence, where possible). Indeed, when the telephone sets in a VTEP are ringing, they will all stop ringing as soon as any one telephone is answered. When a particular VTEP group is not active, a subscriber can pick up any telephone associated with that group to obtain dial tone and place an outbound call. When the called party answers, the connection becomes active and other telephone sets in that VTEP may be picked up by others at that location to join in on the conversation (as in the use of conventional extension telephones). The connection to the called party remains active until the called party hangs up, or until all of the VTEP phones have hung up. Indeed, if a VTEP phone goes off-hook while another telephone set in that VTEP group is already participating in a call, the newest phone to go off-hook joins in on the existing connection.

To configure a VTEP, a subscriber may utilize an interface such as an internal web page supported by the communications gateway. Alternatively, one of the telephone service providers may offer to perform the VTEP configuration for its customers. In either case, the interface creates or modifies the VTEP configuration by allowing the subscriber to create, modify or delete a virtual telephone endpoint, define its VTEP telephone number, and add, modify or delete the various telephone sets (physical endpoints) associated with each VTEP (defining each physical endpoint by type, MAC address, and so on).

The home network may also be able to automatically configure itself. For example, when a subscriber installs a new home networking terminal, the device may optionally use its home networking interface to automatically discover the communications gateway host. The subscriber then uses the device's keypad to associate the new terminal with the desired VTEP group by entering a desired number sequence (for example, the predetermined VTEP group telephone number).

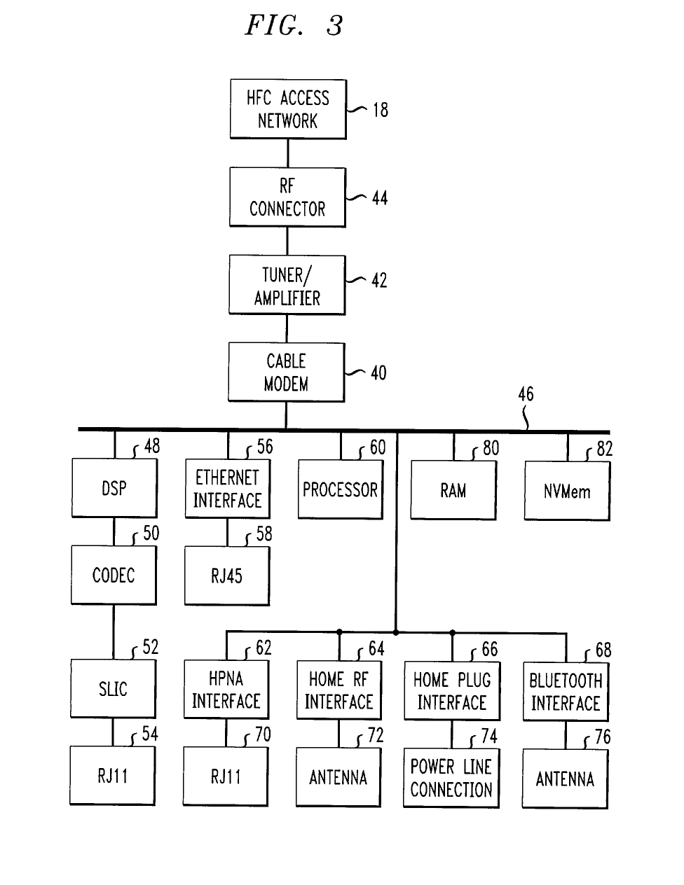

FIG. 3 illustrates the exemplary hardware architecture deployed within a VTEP gateway 16 of the present invention, for providing communication between HFC access network 18 and home network 12. It is to be understood that while the arrangement as depicted in FIG. 3 utilizes various discrete components to perform the required functions (e.g., processor, DSP), a single component (or other arrangements of components) may be used to provide the same functionality and fall within the scope of the present invention.

Referring to FIG. 3, a cable modem 40 is used to carry voice traffic between HFC access network 18 and home network 12, with a tuner/amplifier 42 and RF connector 44 used to provide the requisite signal shaping and physical connections, respectively. In accordance with the present invention, the output of cable modem 40 is connected via a communications bus 46 to the various types of home communications networks within residence 12. A conventional telephone connection is provided through a digital signal processor (DSP) 48 connected to bus 46, where the output of DSP 48 is connected to a coder/decoder (CODEC) 50, then through a SLIC 52 to a conventional telephone jack 54 (RJ11). An Ethernet interface 56 is also coupled to bus 46 to provide a data network connection through a “computer jack” 58 (RJ45) to a voice-over-IP telephone set.

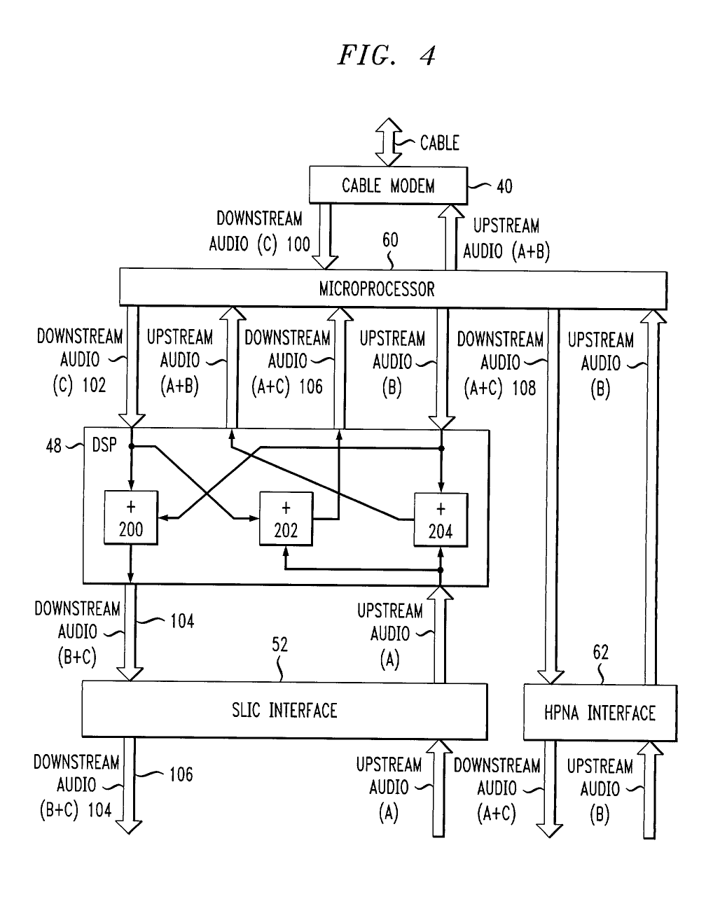

As will be described in more detail in association with FIG. 4, a microprocessor 60 is also coupled to bus 46 and is used to direct voice traffic flow between the various interconnected telephone sets 13 forming each VTEP. Exemplary alternative network interfaces are also shown in FIG. 3 as coupled to bus 46, including an HPNA interface 62, HomeRF interface 64, HomePlug interface 66, and a Bluetooth interface 68. It is to be understood that an exemplary VTEP communications gateway formed in accordance with the present invention may include only one or two alternative network connections, or may include other network types not specifically illustrated or discussed in this exemplary embodiment. As shown, HPNA interface 62 connects through an RJ11 connector 70 to its associated telephone set, HomeRF interface 64 includes an RF transmitter (not shown) that broadcasts to an antenna 72 associated with the HomeRF telephone set. HomePlug interface 66 is used to allow telephone signals to appear at one or more power line connections 74, and Bluetooth interface 68, as shown in FIG. 3, is coupled to antenna 76 of its associated telephone set.

In conventional POTS telephone installations, all of the analog telephone sets connected to a given telephone line can be used to initiate a call, receive a call, or add on as an extension during an existing call, allowing multiple telephones to be off-hook with multiple users participating in the same call. In contrast, when telephone sets are connected to the network through home networking technology, as is the case in the environment of the present invention, there may be some limitations on how many telephone sets may access the home network segment at one time. Further, multiple telephones, even when configured to the same VTEP, may not be able to participate in the same call, as a function of the limited bidirectional communication capabilities within the VTEP communications gateway. Yet, in accordance with the present invention, subscribers are able to pick up any telephone associated with a particular VTEP group and make or receive a call, or be included in an existing call, giving the illusion of the traditional POTS telephone wired extension capability.

To provide the experience of “wired extensions” as described above, DSP 48 within communications gateway 16 is configured to perform mixing of multiple digital audio streams (both “upstream” and “downstream”). FIG. 4 illustrates the call flow within an exemplary portion of a VTEP communications gateway of the present invention, showing only the call flows between two types of network: a conventional telephone network (as depicted by SLIC interface 52) and an HPNA telephone (as depicted by HPNA interface 62). As discussed above, various other networks may become involved in the communication flow; the limitation to two networks in FIG. 4 is only for the sake of simplifying the drawing and associated discussion.

In particular, when an exemplary VTEP group is initially connected to only one physical terminal, DSP 48 is not required for any “mixing” function, since there is nothing to mix. When a second telephone set associated with the same VTEP group goes off-hook (and it is not a priori connected to the first via a traditional wired connection) communications gateway 16 uses DSP 48 to mix the upstream audio from each telephone set and forwards the mixed stream on the network side of the connection. Communications gateway 16 also mixes each upstream transmission, separately, with a downstream audio arriving from the network side of the connection, and forwards these resulting streams toward the telephone sets. Although the upstream transmission, mixing and downstream relay introduces some delay, this configuration of the present invention approximates the operation of a set of conventionally wired telephone sets.

FIG. 4 illustrates an exemplary flow of these audio streams, and the mixing that is performed by DSP 48 in communications gateway 16 to allow for full communication between each telephone set in a VTEP and the communications network. As mentioned above, this particular diagram is limited to illustrating the flow between the HFC access network and a single VTEP including a SLIC-terminated telephone set and an HPNA-terminated telephone set. The purpose of the “mixing” is to allow each listener at a physical endpoint to hear whatever is spoken (as well as the background sounds) at the remote endpoint and all of the other physical end points of that VTEP (that are off-hook and participating in the call). Additionally, the listener at the remote end should receive the “sum” of all of the voice communications from each physical endpoint in the VTEP. For the purposes of discussion, and by reference to FIG. 4, presume that there is a “remote” endpoint C and a pair of physical endpoints A and B forming a VTEP. Physical endpoint A receives the output of physical endpoint B, combined with communication from C. Remote endpoint C receives the output of physical endpoint A combined with the output from physical endpoint B. Conceptually, therefore, for every physical endpoint (as well as for the remote endpoint) there is required to use a “combiner” function that generates the sound to be played out at that endpoint by combining the sounds heard at each of the other endpoints.

The combining (i.e., mixing) function is generally supported by telephony DSP software and is intended to support the conferencing of multiple remote endpoints. As used in this application, the mixing affords the ability to combine the separate physical endpoints at a location into one “virtual” endpoint. Generally, the mixing is performed by adding together individual linear PCM samples from each source, after they have been aligned in time by a jitter buffer and a vocoder (or wave coder) has generated the PCM samples. The resulting linear PCN samples are then converted into the necessary vocoder (wave coder) format and sent to the endpoint for play-out. For example, presume an HPNA device B sends and receives voice data in G.726 format, a POTS line A uses an A-law CODEC, and the remote endpoint uses G.728 format. The data from all three sources is first converted to linear PCM. Then, the data is used to mix to form the output signal to be heard at A, B and C. Lastly, the output signals are converted to the format expected by each of the devices A, B and C.

In looking at the particular communication flow from HFC access network 18, cable modem forwards the downstream audio (designated as audio stream C) along path 100 to microprocessor 60. As will be discussed below, microprocessor 60 recognizes the destination for this audio and performs a protocol translation, if necessary. Microprocessor 60 then forwards audio stream C along path 102 to DSP 48, where it is applied as an input to separate mixers 200 and 202. After passing through mixer 200, audio stream C is applied as an output along signal path 104 and is sent to SLIC interface 52, where is it ultimately received by a telephone set connected through an RJ 11 device to output path 106 from SLIC interface 52. Referring back to DSP 48, downstream audio stream C was also applied as an input to mixer 202, which functions to send this signal to every other telephone set forming this particular VTEP. As shown, the output from mixer 202 propagates along signal path 106 and re-enters microprocessor 60. At this point, audio stream C is tagged to be identified with its remaining termination point (the telephone connected to HPAN interface 62). As a result, audio stream C is coupled as an output onto signal path 108 and is received by HPNA interface 62, forwarding stream C along signal path 110 to the connected telephone set (not shown).

Also illustrated in FIG. 4 is the path taken by upstream audio stream A from the telephone connected to SLIC interface 52, as well as the path taken by upstream audio stream B from the telephone connected to HPNA interface 62. In each instance, mixers 200, 202 and 204 within DSP 48 are used to re-direct the upstream communications to ensure that both upstream paths are sent through microprocessor 60 into cable modem 40, as well as sending upstream audio stream A from SLIC interface 52 through DSP 48 and microprocessor 60 back downward into HPNA interface 62 and, similarly, sending upstream audio stream B from HPNA interface 62 through microprocessor 60 and DSP 48 back downward into SLIC interface 52.

In accordance with the present invention, therefore, the interconnection of the various hardware components within communications gateway 16 provides for the complete interconnection (in terms of downstream and upstream paths) between each physical endpoint device associated with a particular VTEP.

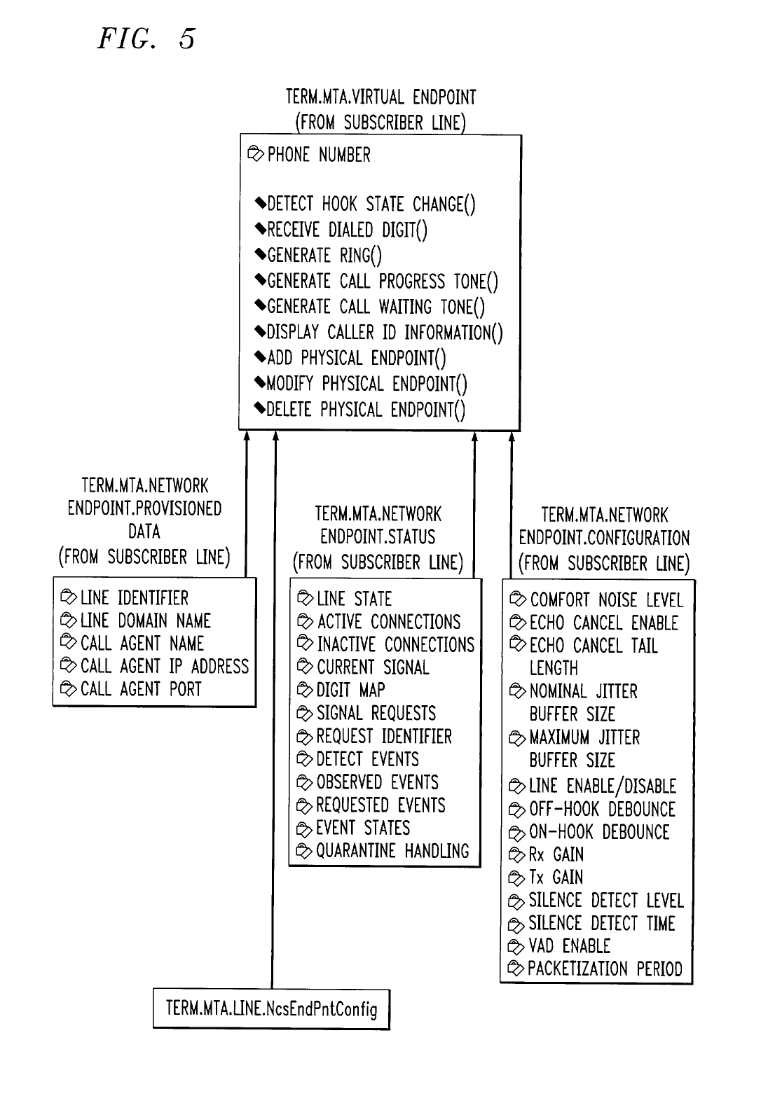

The remainder of this discussion describes in more detail how the multiple telephone sets may be grouped to create the VTEPs supported by communications gateway 16. In particular, FIG. 5 illustrates the relationship between endpoint classes that implement the VTEPs. The Media Telephony Adapter (Term.MTA) class is the parent object in this particular class hierarchy. One MTA exists in the communications gateway, and may “own” between one and four VTEPs. As discussed above, each VTEP is a logical collection of physical endpoints acting as though they are all part of one endpoint, identified by a VTEP telephone number, and a group of operations common to all endpoints, regardless of what type of physical endpoints are installed by the subscriber.

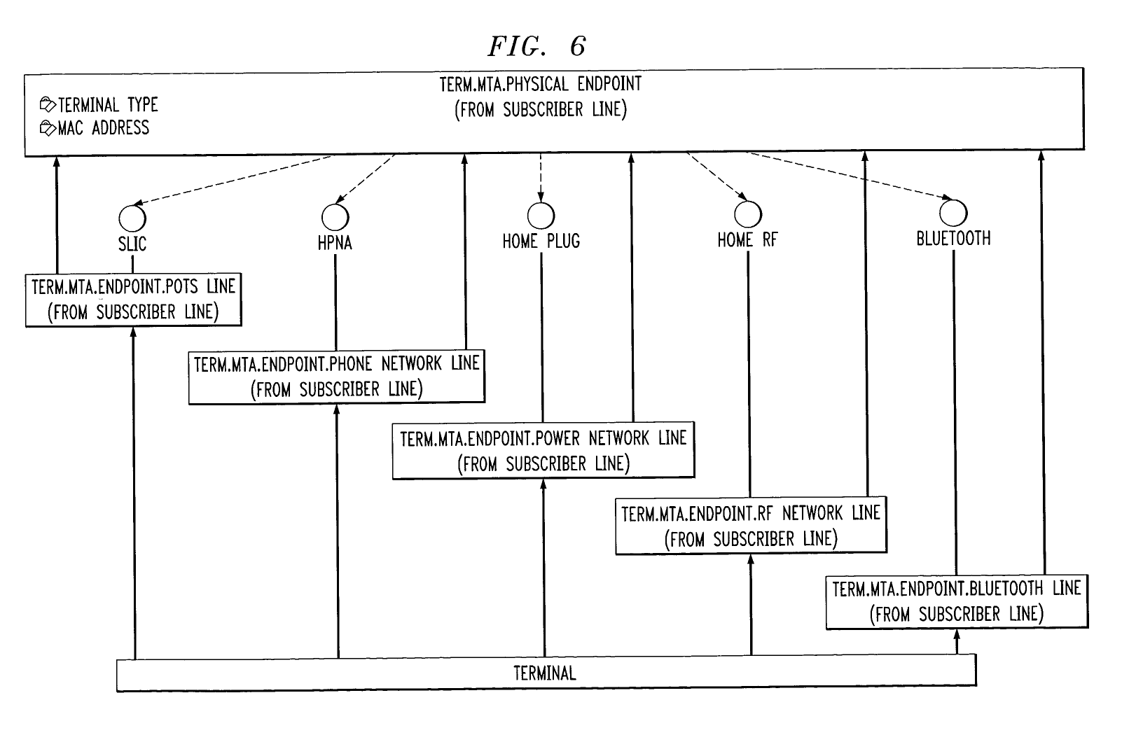

FIG. 6 illustrates the relationship between a physical endpoint and the various types of voice terminals that may be supported by the communications gateway. Each physical endpoint is identified by a terminal type and a hardware MAC address. Depending on the access technology (e.g., POTS, Ethernet, HPNA, HomePlug, HomeRF, Bluetooth), there may be additional identifying information required for operating the communications links between the communications gateway and the telephone sets. These access technologies can be defined as follows: (1) POTS, or “plain old telephone service”, refers to the conventional telephone service provided over the existing home telephone twisted-pair wiring; (2) Ethernet refers to a high-speed data networking connection. In addition to being able to connect home computers in an in-home network, the Ethernet may connect stand-alone “voice or IP” (VOIP) phones, or telephone software configured in a home computer to the communications gateway to provide telephony service, as well as to provide an access to the Internet server. In most cases the homeowner must install special cabling to connect Ethernet devices together; (3) HPNA™ networking technology, or Home Phone Networking Alliance, refers to a home networking technology that enables high-speed data to be transmitted between HPNA-connected devices in the home over the existing conventional telephone twisted-pair wiring. The home owners are able, therefore, to connect multiple computers in a simple network without installing special cabling. A home computer may also be connected to a communications gateway using the existing home telephone wiring. HPNA also provides for adding telephone handsets that, when served by a communications gateway, may be operated on different telephone services than the POTS service on those same twisted pairs. HPNA can be used simply to implement an in-home data network, where the addition of the communications gateway provides an interface to the PSTN and to Internet service providers; (4) HomePlug™ networking technology refers to an arrangement that enables high-speed data and telephony signals to be transmitted by HomePlug devices and a HomePlug-cable communications gateway using the home electrical wiring. As with HPNA, HomePlug can be used simply to implement an in-home data network. The addition of the communications gateway provides an interface to the PSTN and to Internet service provides; (5) HomeRF™ refers to a radio frequency technology that enables high-speed data and telephony signals to be transmitted between HomeRF devices and a HomeRF-capable communications gateway, using radio transmissions, at distances of between 30 and 100 meters. Generally, the communications gateway serves as a “base station” to interface the HomeRF devices to the PSTN, as well as to Internet service providers; (6) Bluetooth™ network technology also refers to a particular radio-frequency technology that enables high-speed data and telephony signals to be transmitted between Bluetooth devices, which could include a Bluetooth-capable communications gateway, using radio at relatively short distances (up to 10 meters, for example) to form ad hoc networks. In such a network, the communications gateway may serve as an interface to the PSTN and to Internet service providers.

The necessary information associated with the particular home networking technology is defined in the class that supports the specific terminal type. The communications gateway also implements interfaces specific to the terminal type. These interfaces, a combination of hardware and software, are used for all operations on specific physical endpoints. In particular, the physical endpoint interfaces as shown in FIG. 6 provide operations that allow translation from network call signaling (SGCP, MGCP or NCS) to the signals required to actuate features and functions at the telephone sets configured on the home network segments. This translation is dependent on the specifics of the home network signals, and must also deal with many different signals and events described for the NCS “line” package, including: DTMF tone detection, answer tone detection, busy tone generation, confirmation tone generation, callerID transmission, dial tone generation, fax tone generation, off-hook transition detection, flash hook detection, on-hook transition detection, modem tone detection, off-hook warning tone generation, distinctive ring pattern generation, normal ring generation, reorder tone generation, ringsplash tone generation, ringback tone generation, stutter dial tone generation, TDD tone detection, visual message waiting indication (VMWI) transmission, and call waiting tone generation.

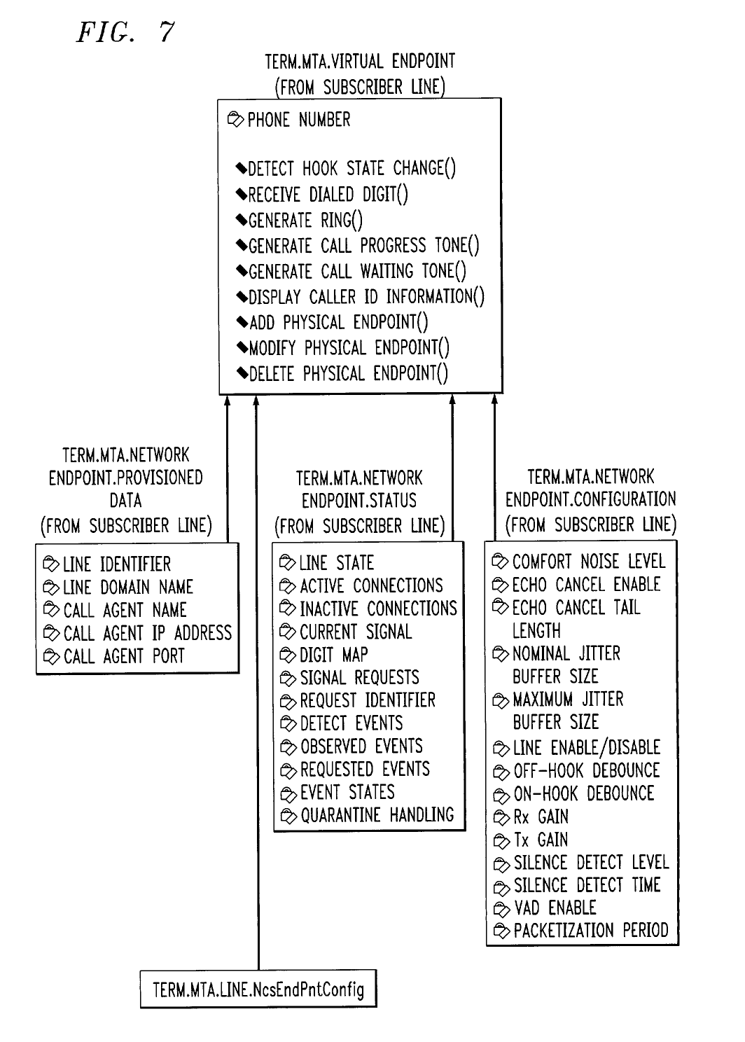

To create a complete, working solution for each VTEP, the communications gateway must implement a number of other interfaces and classes. FIG. 7 illustrates the basic classes required for the communications gateway to operate on a DOCSIS network using PacketCable protocols. These classes reflect the network's view of each VTEP, referred to above as a “network endpoint”. From the network's point of view, each VTEP is a single entity. The existence of multiple physical terminals behind each VTEP is not visible to the network. In particular, the Network Endoint.Provisioned Data class defines the manner in which the communications gateway determines which Call Agent to interact with for telephony operations for the endpoint. The Call Agent is a logical entity hosted elsewhere in a PacketCable network, that controls call operations. The Endpoint Configuration class defines how the communications gateway configures the physical network connection for the endpoint. The NcsEndPntCfg class implements the PacketCable NCS Endpoint Configuration MIB class, and the Endpoint Status class captures current status information for the network endpoint. The communications gateway uses this class to maintain state information about the network endpoint. This aggregates the conditions on the VTEP's physical terminals. For example, if the Signal Requests attribute indicates that the endpoint should be generating a ring to the network endpoint, then the communications gateway is generating a ring on all of the physical endpoints grouped into the associated VTEP.

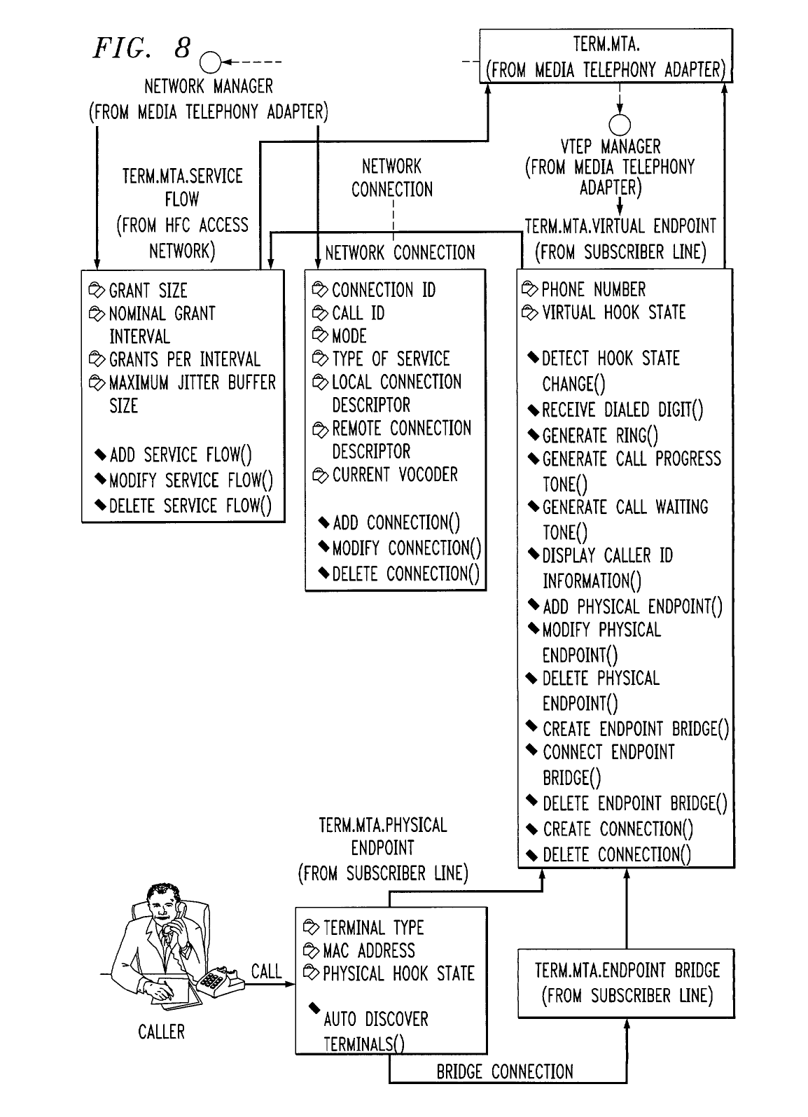

FIG. 8 illustrates the operation of the VTEPs in accordance with the present invention. When the communications gateway receives a request from the network (for example, to create a connection at one of the gateway's endpoints), the gateway's Media Telephony Adapter (MTA) uses the VTEP Manager interface to identify the endpoint, and its Network Manager to create the required connection. The gateway may receive a command from the network to ring on that endpoint. The MTA uses the VTEP Manager interface to ring the virtual endpoint. In turn, the VTEP uses the appropriate physical endpoint interfaces, as shown in FIG. 6, to send a ring command to each physical endpoint. Other signals, such as call progress signals, are sent only to those endpoints that become active (off hook). Events, such as dialed digits and hook state changes are detected by the physical endpoints and relayed to the VTEP. The MTA uses the VTEP Manager to collect the events and transmit them to the network, using the following rules: (1) when a physical endpoint goes off-hook, the VTEP Manager records the hook state. If no other physical endpoint in the VTEP is off-hook, the virtual state of the VTEP becomes “off-hook”, and the VTEP Manager reports the state change to the MTA for signaling on the network; (2) when a physical endpoint goes on-hook, the VTEP Manager records the hook state. If all physical endpoints now are on-hook, the virtual state of the VTEP becomes “on-hook”, and the VTEP Manager reports the state change to the MTA for signaling on the network; (3) all flash hook events reported by a physical endpoint in a VTEP are handled as a virtual flash hook event and reported for signaling on the network; and (4) only dialed digits reported by the first physical endpoint to report a dialed digit are reported to the MTA for signaling on the network.

When a physical endpoint becomes “active” (i.e., goes “off-hook”) which another physical endpoint of the same VTEP is on a phone call, a new mixing function is added that combines the remote endpoint and all of the active physical endpoints, except for the newly-activated endpoint. The output of this mixing function is routed to the newly-activated physical endpoint and any transcoding is performed, as necessary. The sound data captured at the newly-activated physical endpoint is routed to and added to the existing mixing functions for each of the other active physical endpoints and to the mixing function of the remote endpoint. If the physical endpoint is the first active physical endpoint of a particular VTEP in the phone call, the call is handled as a simple IP phone call connection.

When a physical endpoint of a VTEP which has been participating in a phone call becomes “inactive” (i.e., goes “on-hook” for a period of time longer than a flash hook), it will be removed from the call. If that physical endpoint was the only active physical endpoint in the VTEP, the deactivation is handled in a manner similar to the deactivation of a simple IP phone call. If there are other active physical endpoints in the VTEP, then the mixing function of the physical endpoint becoming inactive is eliminated, along with related reformatting/transcoding functions. Additionally, the inactive physical endpoint is removed as an input for the mixing functions associated with the remaining active physical endpoints.

When the communications gateway receives a “create connection” command during the establishment of a network connection, it performs these operations: (1) configures each of the physical endpoints to begin vocoder operation, through the VTEP Manager; (2) reserves HFC access network bandwidth, through the Network Manager; (3) if there is more than one physical endpoint off-hook in the VTEP and/or a physical endpoint lacks the necessary vocoder, the VTEP Manager allocates an “endpoint bridge” and reserves conferencing and transcoding resources of the DSP hardware; and (4) establishes necessary voice data paths between the physical endpoints and the endpoint bridge, and between the virtual endpoint and the network service flow. When the communications gateway receives a “delete connection” command, it performs the following operations: (1) stops vocoder operations at the affected physical endpoints, through the VTEP Manager; (2) frees HFC access network bandwidth, through the Network Manager, (3) discards any endpoint bridge allocated for the VTEP, and frees the DSP resources; and (4) discards the voice paths established to support the connection. Lastly, when the communications gate receives a “modify connection” command, it performs the following operations: (1) reconfigures the physical endpoints to start or stop vocoder operation, or change characteristics of the vocoder, if required, through the VTEP Manager, (2) allocates or frees HFC access network bandwidth, through the Network Manager, (3) allocates to frees DSP resources, if required; and (4) reconfigures the voice paths, if required.

While the above discussion is useful in understanding various details regarding specific embodiments of the present invention, it is to be understood that the subject matter of the present invention is intended to be limited only by the scope of the claims appended hereto.

What is claimed is:

1. A communications gateway for providing bidirectional communication between an HFC access network and a subscriber location, said subscriber location including telephone sets in communication with a plurality of different telecommunications networks, the communications gateway including
a microprocessor for designating subscriber-determined subsets of said telephone sets as separate virtual telephony endpoints, each virtual telephony endpoint subset associated with a different virtual telephone number such that separate telephone sets associated with different telecommunications networks function as extensions of the same virtual telephone number.

2. A communications gateway as defined in claim 1 wherein the communications gateway further includes
a modem for receiving downstream communication from the HFC access network destined for one virtual telephone endpoint and transmitting upstream communication from each virtual telephony endpoint to said HFC access network; and
a DSP to provide mixing of the upstream and downstream communications and directing the communications between each telephone set in a virtual telephony endpoint.

3. A communications gateway as defined in claim 1 wherein the subscriber-determined subsets of telephones are configured by the subscriber through a communications gateway web interface.

4. A communications gateway as defined in claim 3 wherein the subscriber-determined configuration includes: creating, modifying, deleting a virtual endpoint; defining a virtual telephone number to be associated with each physical endpoint in a virtual endpoint group; and adding, modifying, deleting physical endpoints from various virtual endpoints.

5. A communications gateway as defined in claim 1 wherein the subscriber-determined subsets of telephones are configured by a communications service provider on behalf of the subscriber.

6. A communications gateway as defined in claim 5 wherein the subscriber-determined configuration includes: creating, modifying, deleting a virtual endpoint; defining a virtual telephone number to be associated with each physical endpoint in a virtual endpoint group; and adding, modifying, deleting physical endpoints from various virtual endpoints.

7. A communications gateway as defined in claim 1 wherein the different telecommunications networks are chosen from a group consisting of: a conventional PSTN network for POTS telephone sets, a data-connected network for voice-over-IP telephone sets, an RF network for RF-based telephone sets, and a power utility network for power-connected telephone sets.
